(19) United States
(12) Patent Application Publication
(10) Pub. No.: US 2010/0212999 A1
(43) Pub. Date: Aug. 26, 2010

(54) HELMHOLTZ RESONATOR

(76) Inventors: David Shawn Marion, Chatham (CA); Stephen Francis Bloomer, London (CA); Jianrui Ye, Tilbury (CA); Richard Donald McWilliam, Shedden (CA); Phillip Edward Arthur Stuart, Chatham (CA); Jason Lorne Pettipiece, Chatham (CA)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/593,178

(22) PCT Filed: Mar. 26, 2008
(86) PCT No.: PCT/EP08/53523

§ 371 Date: Mar. 22, 2010

Related U.S. Application Data
(60) Provisional application No. 60/908,557, filed on Mar. 28, 2007.

(51) Int. Cl. F01N 1/02; G10K 11/172

(52) U.S. Cl. 181/250

(57) ABSTRACT

The invention relates to a Helmholtz resonator (6) for damping airborne sound in a space, particularly in a conduit (4, 5) transporting airborne sound, comprising a housing (8) surrounding a resonance volume (9), comprising at least one neck (10) for connecting the resonance volume (9) to the space or to the conduit (4, 5) transporting the airborne sound. The Helmholtz resonator (6) obtains at least two resonance frequencies if the housing (8) has at least one wall section delimiting the resonance volume (9), said wall section being formed by a vibratory membrane (11), and if the membrane (11) is tuned such that the resonance frequency thereof corresponds to the first order of the resonance frequency of an identically constructed Helmholtz resonator that does not have such a membrane (11).

The present invention relates to a Helmholtz resonator for damping airborne sound in a space, in particular in a conduit transporting airborne sound. The invention moreover relates to a gas delivery system for an internal combustion engine, in particular a motor vehicle, as well as a sound absorber for such a gas delivery system, each of which is provided with such a Helmholtz resonator.

The Helmholtz resonator is generally known in the field of acoustics and serves to damp airborne sound. For example, such Helmholtz resonators are used in fresh air systems and exhaust gas systems of internal combustion engines, in particular in motor vehicles, in order to dampen in a targeted manner certain disruptive frequencies. Customarily, a Helmholtz resonator has a resonance volume that is enclosed in a housing and that communicates by means of a neck with that space in which the sound to be damped spreads. The Helmholtz resonator works like a spring-mass oscillator the spring of which is formed by the resonance volume and the mass of which is formed by the air mass vibrating in the neck. Such Helmholtz resonators can be comparatively precisely calculated and accordingly relatively precisely designed. In principle, they can be designed based on only a certain resonance frequency that is comparatively deep. It is, in principle, also moreover conceivable to connecting a shared resonance volume over two different necks with the space to be damped, by means of which the Helmholtz resonator has two different resonance frequencies.

The present invention addresses the problem of providing for a Helmholtz resonator of the abovementioned type or for a gas delivery system equipped therewith or for a sound absorber equipped therewith an improved embodiment that is characterised in particular by the fact that at least two resonance frequencies are realisable with relatively minimal outlay.

This problem addressed by the invention is solved by the subject matter of the independent claims. Advantageous embodiments are the subject matter of the dependent claims.

The invention is based on the general concept of equipping the housing of the Helmholtz resonator with at least one vibratory membrane that is designed in such a manner that its resonance frequency of the first order substantially corresponds to those resonance frequencies that an Helmholtz resonator of identical construction without such a membrane would have. This method of construction results in the membrane, in the range of its resonance frequency, being excited to vibrations, which minimally weakens the damping effect of the Helmholtz resonator in comparison to a structurally identical Helmholtz resonator without such a membrane, however in an adjacent first frequency range that is below the resonance frequency of the membrane, as well as in an adjacent second frequency range that it above the resonance frequency of the membrane, each respectively exhibiting the damping effect that demonstrates a significantly increased damping effect in both of these frequency ranges in comparison to a structurally identical Helmholtz resonator with such a membrane. The Helmholtz resonator constructed according to the invention thus has on both sides of the resonance frequency of the membrane two different frequencies with a maximal damping effect. Both of these frequencies thus form two resonance frequencies of the Helmholtz resonator according to the invention. They can be comparatively precisely pre-tuned. By means of both of the resonance frequencies, the proposed Helmholtz resonator receives a certain broadband activity, namely between its resonance frequencies. The Helmholtz resonator designed in such a manner can thereby be effectively used, in particular in varying environmental conditions as well.

Accord to an advantageous embodiment, the housing can have at least one covering that on an external side of the housing that is opposite the resonance volume seals the wall section that has the membrane in an additional, in particular gas-tight, volume. In this manner, the damping effect of the membrane can be decoupled in a certain amount from the environmental conditions of the Helmholtz resonator, such as pressure and temperature, for example. Thus, the damping effect of the Helmholtz resonator in the range of both of the resonance frequencies can be guaranteed in a broad operational range, for example, with respect to pressures and/or temperatures.

Additional important features and advantages of the invention can be found in the dependent claims, in the drawings, and in the pertinent description of the figures with reference to the drawings.

It is understood that the features described above and those to be described in what follows can be used not only in the particular cited combination; but also in other combinations or independently without departing from the scope of the present invention.

Preferred embodiments of the invention are shown in the drawings and are described in more detail in the following description, the same reference numerals referring to components which are the same or functionally the same or similar.

They schematically show respectively in

FIG. 1 a very simplified principle representation of a gas delivery system in the manner of a circuit diagram,

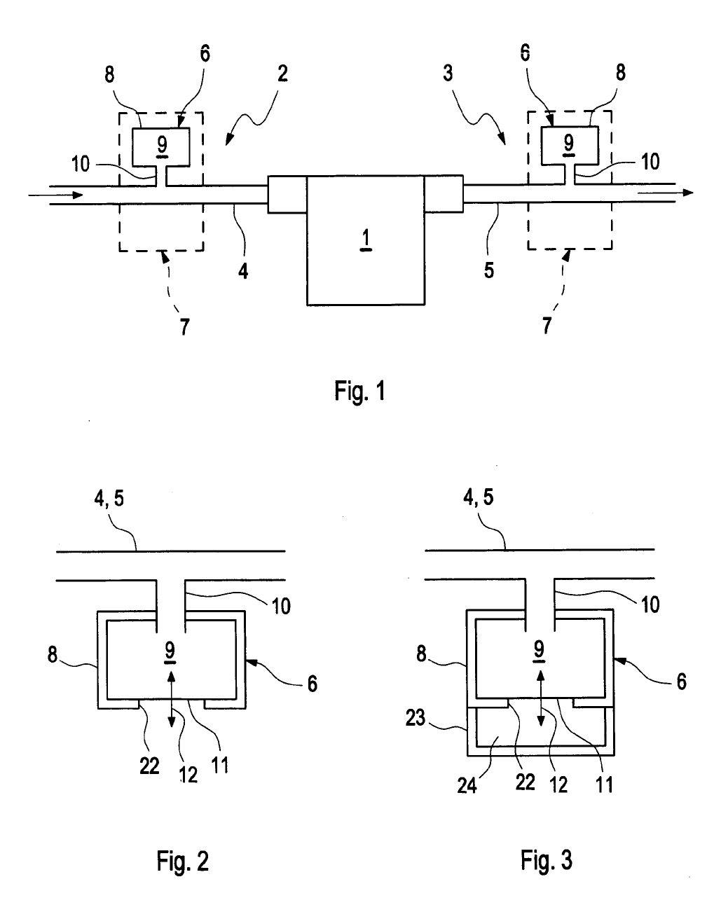

FIGS. 2-5 very simplified views of Helmholtz resonators in different embodiments,

FIG. 6 a diagram for the visualisation of the frequency-dependent damping effect of a Helmholtz resonator.

Corresponding to FIG. 1, a gas delivery system 2 for supplying fresh air, or a so-called air supply system 2 can be connected to a conventional internal combustion engine 1 on the inlet side, and a gas delivery system 3 for removing exhaust gas, a so-called exhaust system 3, can be connected to a conventional internal combustion engine 1 on the outlet side. The respective gas delivery systems 2, 3 each has at least one gas carrying line 4 or 5, respectively, wherein a Helmholtz resonator 6 or a sound damper 7, respectively, can be connected to at least one of these lines 4, 5, which sound damper contains at least one such Helmholtz resonator 6. In the example shown, not only the air supply system 2 can be equipped with such a sound damper 7 or with such a Helmholtz resonator 6, but also the exhaust system 3. It is evident that the respective lines 4 and 5 can contain more than one such Helmholtz resonator 6 or more than one such sound damper 7. Moreover, it is likewise evident that the respective sound damper 7 can contain more than one such Helmholtz resonator 6.

Corresponding to FIGS. 1 to 5, one such Helmholtz resonator 6 comprises a housing 8 that encloses a resonance volume 9, in particular a gas tight one, as well as at least one neck 10 that connects the resonance volume 9 with a space, in this instance with a line, namely the fresh air line 4 or with the exhaust gas line 5, that transports airborne sound. The Helmholtz resonator 6 serves to damp the airborne sound transported in the respective line 4, 5. It is important for the Helmholtz resonator 6 here arranged in the shunt circuit that its housing 8 externally encloses in a gas tight manner the resonance volume 9 outside the respective neck 10.

Corresponding to FIGS. 2 to 5, each housing 8 has at least one membrane 11 capable of vibrating that forms the wall section of the housing that delimits the resonance volume 9. This membrane 11 is designed in such a manner with regard to its resonance frequency for vibrations that travel corresponding to a double arrow 12 perpendicular to the plane of the membrane, that the first order of this resonance frequency corresponds to that resonance frequency of a structurally identical Helmholtz resonator that does not have such a membrane 11.

The effect of such a membrane 11 with the calibration according to the invention is described in greater detail with reference to FIG. 6. In the diagram of FIG. 6, the acoustic damping is plotted on the ordinates in decibel dB, while the acoustic frequency is plotted on the abscissa in hertz Hz. a damping course 13 of a structurally identical Helmholtz resonator that does not have such a membrane 11 is plotted with a broken line. This course 13 recognisably has a maximum 14 with a resonance frequency 15 of this Helmholtz resonator that has no membrane but is otherwise structurally identical. This resonance frequency 15 of the Helmholtz resonator without a membrane corresponds to the first order of the resonance frequency of the membrane 11. Furthermore, the diagram of FIG. 6 contains a course 16 that reproduces the dependence of the damping of the frequency of the Helmholtz resonator 6 according to the invention with such a membrane 11. The damping effect initially recognisably increases to a first maximum 17 by means of which the Helmholtz resonator 6 according to the invention has a first resonance frequency 18. After this first resonance maximum 17, the damping effect decreases to a minimum 19 that is in the range of the resonance frequency 15 of the structurally identical Helmholtz resonator that however lacks a membrane, that is to say that is in the range of the resonance frequency of the membrane 11. Finally, the damping effect increases again to a second maximum 20 at which the Helmholtz resonator 6 according to the invention has a second resonance frequency 21. The specially designed membrane 11 thus recognisably produces, in contrast to conventional Helmholtz resonators that do not have membranes, instead of one single resonance frequency 15 two resonance frequencies 18, 21 the damping maxima 17, 20 of which are arranged approximately mirror symmetrically to the resonance frequency 15 of the conventional Helmholtz resonator that has no membrane.

The respective membrane 11 can be manufactured integral with the remainder of the housing 8, in particular, for example by injection moulding of plastic. The membrane 11 differs from the remainder of the housing 8 by its thickness in particular, which can be considerably reduced with respect to the thickness of the remainder of the housing 8. At least in the region of their connection to the surrounding housing 8, the membrane 11 can be designed as capable of vibrating in such a manner that it can deform in a flexibly resilient manner in order to carry out the desired vibrational motions 12. In contrast thereto, the remainder of the housing 8 outside of the membrane 11 is designed to be comparably rigid. In particular, the housing 8 is so rigidly designed outside of the respective membrane 11 that an optionally present resonance frequency of the housing 8 outside of the respective membrane 11 is at least ten times greater, with regard to its first order, than the resonance frequency 15 of the structurally identical Helmholtz resonator without a membrane. In other words, in so far as the housing 8 has a resonance frequency itself, the first order thereof is at least ten times greater than the resonance frequencies 18, 21 of the Helmholtz resonator 6.

For the targeted design of the resonance frequency of the membrane 11 that is intended to coincide with the resonance frequency 15 of the Helmholtz resonator without a membrane, the membrane 11 can be designed in a manner suitable so that it differs from the remainder of the housing 8, in particular by the material selected, the thickness selected, as well as by a profile, optionally, and also by its shape.

In the examples shown, the respective housing 8 contains a housing opening 22 for the respective membrane 11, which housing opening is sealed by the respective membrane 11.

In the embodiment shown in FIG. 3, the housing 8 has at least one covering 23. Said covering is arranged on an exterior portion of the housing 8 that is facing away from the resonance volume 9 in such a manner that it covers the wall section that forms or contains the membrane 11 and seals an additional volume, preferably in a gas tight manner. By means of this style of construction, a certain decoupling of the damping effect of the membrane 11 from the environmental conditions, such as temperature and pressure, for example, of the Helmholtz resonator 6 can be achieved. It is preferable thereby that the covering 23 be designed as more rigid than the membrane 11. Furthermore, the covering 23 is preferably designed to be less rigid than the housing 8 outside the membrane 11. In principle, an embodiment is conceivable in which the covering 23 is produced, in particular, from the same material as the remainder of the housing 8.

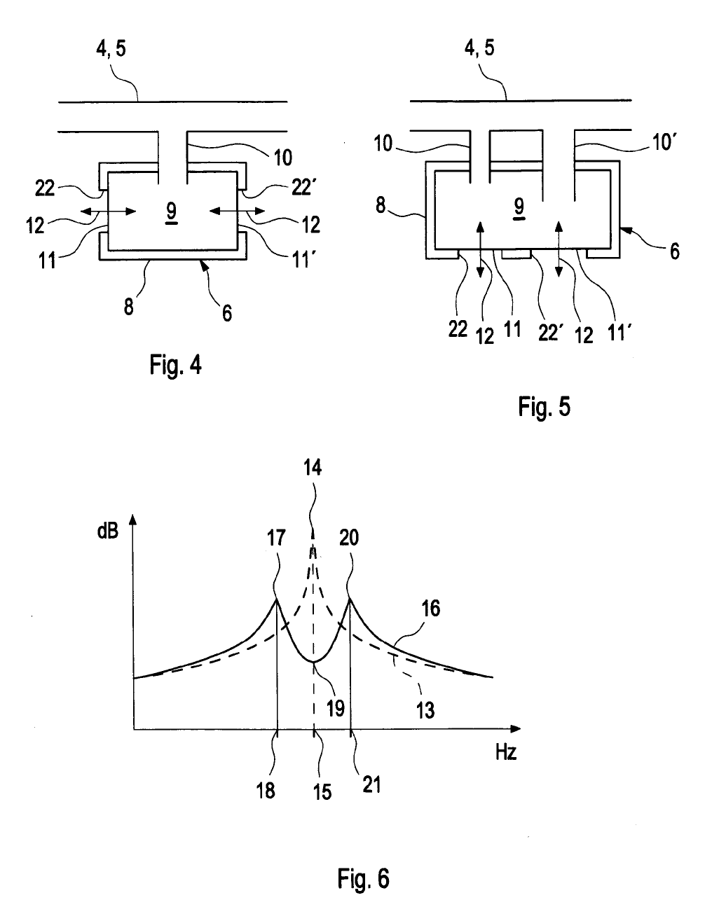

In the embodiment shown in FIG. 4, two membranes 11 and 11′ are shown purely by way of example. In theory, more than two membranes 11, 11′ can be provided. Both of the membranes 11, 11′ can be designed as identical to one another. Likewise, if they have different configurations, they can be tuned for the same resonance frequency. An embodiment is likewise possible in which both of the membranes 11, 11′ are tuned for different resonance frequencies. In this manner, the damping maxima 17, 20 can be more broadly configured.

In the embodiment shown in FIG. 5, two necks 10 and 10′ are shown purely by way of example. It is in principle possible for more than two necks 10, 10′ to be provided. In the example shown, both of the necks 10, 10′ are designed to be different from one another in such a manner that the Helmholtz resonator 6 already has two different resonance frequencies owing to both of the necks 10, 10′. For example, both of the necks 10, 10′ differ from one another with regard to cross section and/or through their length. In the example shown in FIG. 5, the housing 8 is moreover equipped with two membranes 11 and 11′, which is similar to the embodiment shown in FIG. 4. It is preferable that the two membranes 11, 11′ in the embodiment shown in FIG. 5 are differently tuned. Each of these membranes 11, 11′ is tuned for a different resonance frequency of a structurally identical Helmholtz resonator with the two different necks 10, 10′ however without the membranes 11, 11′. It is in this manner that the interrelationship shown in FIG. 6 results for both “intended” resonance frequencies of the structurally identical Helmholtz resonators without a membrane. Accordingly, a total of four resonance frequencies are present for the Helmholtz resonator 6, according to the invention, with two different necks 10, 10′.

1. A Helmholtz resonator for damping airborne sound in a space transporting airborne sound, comprising:
a housing surrounding a resonance volume, and
at least one neck for connecting the resonance volume to the space,
wherein the housing has at least one wall section delimiting the resonance volume, said wall section being formed by a vibratory membrane,
wherein the membrane is tuned such that a resonance frequency thereof corresponds to a first order of the resonance frequency of a structurally identical Helmholtz resonator that does not have the membrane.

2. The Helmholtz resonator as specified in claim 1, wherein the housing has at least one covering that seals in an additional resonance volume, and wherein the wall section is one of having and forms the membrane, said covering being on an external side of the housing, which faces away from the resonance volume.

3. The Helmholtz resonator as specified in claim 2, wherein the covering is more rigid than the membrane.

4. The Helmholtz resonator as specified in claim 2, wherein the covering is one of less rigid than and about as rigid as the housing outside of the membrane.

5. The Helmholtz resonator as specified in claim 1, wherein the membrane differs from the remaining housing by at least one of the material, thickness, profile and form.

6. The Helmholtz resonator as specified in claim 1, wherein the housing is relatively rigid outside of the membrane.

7. The Helmholtz resonator as specified in claim 6, wherein the housing outside of the membrane is rigid such that a resonance frequency of the first order is at least ten times greater than the resonance frequency of the structurally identical Helmholtz resonator without the membrane.

8. The Helmholtz resonator as specified in claim 1, wherein:
i. the Helmholtz resonator has at least two necks that are different from one another with regard to at least one of cross section and length such that the Helmholtz resonator is generally identical to a Helmholtz resonator that has no membrane and at least two different resonance frequencies, and
ii. the housing has at least two membranes that are each tuned to one of the different resonance frequencies of the Helmholtz resonator that has no membrane.

9. (canceled)

10. (canceled)

11. The Helmholtz resonator as specified in claim 1, wherein the Helmholtz resonator is connected to at least one gas conducting line and is part of a gas delivery system for an internal combustion engine for a motor vehicle, and is one of for supplying fresh air and for removing exhaust gas.

12. The Helmholtz resonator as specified in claim 1, wherein the Helmholtz resonator is connected to at least one gas conducting line and is part of sound absorber for a gas delivery system for an internal combustion engine for a motor vehicle, and is one of for supplying fresh air and for removing exhaust gas.

13. The Helmholtz resonator as specified in claim 3, wherein the covering is one of less rigid than and about as rigid as the housing outside of the membrane.

14. The Helmholtz resonator as specified in claim 2, wherein the membrane differs from the remaining housing by at least one of the material, thickness, profile and form.

15. The Helmholtz resonator as specified in claim 2, wherein the housing is relatively rigid outside of the membrane.

16. The Helmholtz resonator as specified in claim 15, wherein the housing outside of the membrane is rigid such that a resonance frequency of the first order is at least ten times greater than the resonance frequency of the structurally identical Helmholtz resonator without the membrane.

17. The Helmholtz resonator as specified claim 2, wherein:
i. the Helmholtz resonator has at least two necks that are different from one another with regard to at least one of cross section and length such that the Helmholtz resonator is generally identical to a Helmholtz resonator that has no membrane and at least two different resonance frequencies, and
ii. the housing has at least two membranes that are each tuned to one of the different resonance frequencies of the Helmholtz resonator that has no membrane.

18. The Helmholtz resonator as specified in claim 3, wherein the membrane differs from the remaining housing by at least one of the material, thickness, profile and form.

19. The Helmholtz resonator as specified in claim 3, wherein the housing is relatively rigid outside of the membrane.

20. The Helmholtz resonator as specified in claim 19, wherein the housing outside of the membrane is rigid such that a resonance frequency of the first order is at least ten times greater than the resonance frequency of the structurally identical Helmholtz resonator without the membrane.

21. The Helmholtz resonator as specified claim 3, wherein:
i. the Helmholtz resonator has at least two necks that are different from one another with regard to at least one of cross section and length such that the Helmholtz resonator is generally identical to a Helmholtz resonator that has no membrane and at least two different resonance frequencies, and
ii. the housing has at least two membranes that are each tuned to one of the different resonance frequencies of the Helmholtz resonator that has no membrane.

22. The Helmholtz resonator as specified in claim 4, wherein the membrane differs from the remaining housing by at least one of the material, thickness, profile and form.
